(19) United States
(12) Patent Application Publication
(10) Pub. No.: US 2010/0102908 A1
(43) Pub. Date: Apr. 29, 2010

(54) ANNULAR MULTI-CELL ENDLESS BOX GIRDER APPARATUS FOR A QUENCH AVOIDANT COLDMASS IN AN MRI MAGNET

(75) Inventor: SOU TIEN WANG, DANVILLE, CA (US)

Correspondence Address: PATENTRY, P.O. BOX 151616, SAN RAFAEL, CA, 94915-1616, US

(73) Assignee: WANG NMR INC, LIVERMORE, CA (US)

(21) Appl. No.: 12/257,399

(22) Filed: Oct. 24, 2008

(51) Int. Cl. H01F 6/06

(52) U.S. Cl. 335/216

(57) ABSTRACT

An apparatus for MRI magnets allows shorter bores with strong homogenous imaging fields comprising an extremely rigid box girder for to prevent magnet quench due to deformation. The coldmass of the magnet comprises at least three co-axial cylinders as formers for superconducting coils and further comprises a plurality of annuluses to form a helium vessel and a multi-layer, multi-cell cylindrical annular box girder. The cylinders and annuluses are dimensioned as webs and flanges in endless closed box girders, also called box beams, providing a high moment of inertia structure in non-magnetic stainless steel to support 50-100 tons of electromagnetic force with only trace deformation.

### BACKGROUND

Magnetic resonance imaging (MRI) is primarily a medical imaging technique most commonly used in radiology to visualize the structure and function of the body. It provides detailed images of the body in any plane. MRI provides much greater contrast between the different soft tissues of the body than does computed tomography (CT), making it especially useful in neurological (brain), musculoskeletal, cardiovascular, and oncological (cancer) imaging. Unlike CT, it uses no ionizing radiation, but uses a powerful magnetic field to align the nuclear magnetization of (usually) hydrogen atoms in water in the body. Radiofrequency fields are used to systematically alter the alignment of this magnetization, causing the hydrogen nuclei to produce a rotating magnetic field detectable by the scanner. When a person lies in a scanner, the hydrogen nuclei (i.e., protons) found in abundance in the human body in water molecules, align with the strong primary magnetic field. A second electromagnetic field, which oscillates at radiofrequencies and is perpendicular to the primary field, is then pulsed to push a proportion of the protons out of alignment with the primary field. These protons then drift back into alignment with the primary field, emitting a detectable radiofrequency signal as they do so.

### Magnet Quench

A quench occurs when part of a superconducting coil transforms into the normal resistive state. This is because either the field inside the magnet exceeds critical field strength, the rate of change of field is too great causing too much eddy current heating in the copper support matrix, or the conductor temperature exceeds its critical temperature value due to frictional heating or epoxy cracking. When quench happens, that particular non-superconducting spot is subject to rapid joule heating, which raises the temperature of the surrounding regions. This heat further spreads the normal state propagation which leads to more heating. The entire magnet rapidly within a few seconds becomes normal and consumes the entire stored energy of the magnet. This is accompanied by a percussive rapid vaporization of the cryogen. Permanent damage to the magnet can occur if the magnet is not properly protected. Economically, a quench requires a magnet to be recooled, reenergized and reshimmed to recover to a stable and homogenous field suitable for imaging. Recooling, reenergizing, and reshimming a magnet results in weeks of non-production. These efforts require on-site services by field engineers for weeks to recover to a stable homogenous field. Cryogen, its cost of delivery, and field service are very costly.

Magnetic field strength is an important factor in determining image resolution and speed. Higher magnetic fields increase signal-to-noise ratio, permitting higher resolution or faster scanning. However, higher field strengths require more costly magnets with higher fringing field, and have increased patient safety concerns. Nowaday, one Tesla through three Tesla field strengths are a good compromise between cost and performance and are FDA approved for general clinical use. However, for certain specialist medical research uses (e.g., brain functional imaging), field strengths of 4.0 Tesla and higher will be needed.

The lack of harmful effects on the patient and the operator make MRI well-suited for “interventional radiology”, where the images produced by a MRI scanner are used to guide minimally-invasive procedures. Of course, such procedures must be done to avoid ferromagnetic instruments.

In the US, the 2007 Deficit Reduction Act (DRA) significantly reduced reimbursement rates paid by federal insurance programs for the technical component of many scans, shifting the economic landscape. Many private insurers have followed suit.

Currently, in the US, there is increasing interest in reducing the costs associated with MRI services and simultaneously improving the ability to effectively and efficiently provide MRI examination services to larger numbers of patients with improved efficiency in equipment and space utilization.

While the additional capabilities of MRI technology make them increasingly attractive, there are drawbacks discouraging and inhibiting wide-spread adoption. These include noise, size, tightness, and tradeoffs with scan quality. Better image contrast and speed of results is a benefit of adopting newer technology with stronger fields.

Due to the construction of some MRI scanners, they can be subjectively unpleasant to lie in. Older models of closed bore MRI systems feature a fairly long tube or tunnel. The part of the body being imaged needs to lie at the center of the magnet which is at the absolute center of the tunnel. Because scan times on these conventional MRI machines may be long (occasionally up to 40 minutes for the entire procedure), people with even mild claustrophobia are sometimes unable to tolerate an MRI scan without some patient comfort management.

For babies and young children chemical sedation or general anesthesia are the norm, as these subjects cannot be instructed to hold still during the scanning session. Pregnant women may also have difficulty lying on their backs for an hour or more without discomfort. Acoustic noise associated with the operation of an MRI scanner can also exacerbate the suffering associated with the procedure.

A cylinder is herein defined as a ruled surface spanned by a one-parameter family of parallel lines. Commonly, cylinders are thought of as right circular cylinders but generally may be elliptical cylinders, parabolic cylinders, hyperbolic cylinders or polygonal cylinders. A hexagonal or octagonal tube corresponds to a polygonal cylinder.

A polygonal annulus is defined herein as the difference region between two scaled copies of some polygon P. A circle or ellipse corresponds to a single sided polygon. Commonly an annulus is thought of as the difference region between two concentric circles but within this application we mean a polygonal annulus of one or many sides.

### SUMMARY OF THE INVENTION

It is known that a box girder provides a high moment of inertia structural element for architecture and structural mechanics against gravitational and seismic forces. An example of a conventional open box girder is the covered wooden bridge which supports an interior roadway in vertical loading. The present invention closes a plurality of endless box girders by coupling annuluses and cylinders to provide a multi-layer multi-cell annular box girder which has inner and outer cylinders for webs and annuluses for flanges which enclose superconducting coil elements. A cryogen vessel in a superconducting MRI magnet of the presently disclosed invention is defined by the space enclosed between a primary box girder and a secondary shield box girder. Superconducting coil elements occupy the interior of each annular box girder cell bounded by two concentric cylinders and two parallel annuluses. These structural designs are very strong against deflection in both the radial and the axial directions.

### BRIEF DESCRIPTION OF THE DRAWINGS

FIG. 1 is a conventional box girder in perspective showing cross-section

FIG. 2 is an annular box girder in perspective showing cross-section.

FIG. 3 is a multi-cellular box girder in cross-section.

FIG. 4 is an annular multi-cellular box girder in perspective.

FIG. 5 is a perspective view of a coldmass having multi-layer box girders.

FIG. 6 is a view of a quench avoidant coldmass of an mri magnet.

### FIGURE REFERENCES

100 Conventional box girder

110 Conventional box girder flanges

120 Conventional box girder webs.

200 Annular box girder

210 Annular flange

220 Inner cylindrical web

230 Outer cylindrical web.

300 Multi-cell co-axial parallel annular box girder

310 Parallel annular flanges

320 Inner cylindrical box girder web

330 Outer cylindrical box girder web.

400 Cutaway multi-cell co-axial parallel annular box girder in perspective

410 Parallel annular flanges

420 Inner cylindrical box girder web

430 Outer cylindrical box girder web.

500 Coldmass

531 Shield coil outer cylindrical box girder web

532 Shield coil parallel annular flanges

533 Shield coil inner cylindrical box girder web

541 Primary coil inner cylindrical box girder web

542 Primary coil parallel annular flanges

543 Primary coil outer cylindrical box girder web wall

550 Gussett.

600 Coldmass with view of superconducting coil elements

610 Superconducting shield coil elements

620 Superconducting primary coil elements

630 Interior of liquid helium vessel.

### DETAILED DISCLOSURE OF EMBODIMENTS

It is the observation of the inventor that conventional high field superconducting magnets frequently experience “quench”, losing their magnetic field due to conductor heating because of conductor frictional motion or epoxy cracking. This is due to the excessive deformation of the conductor winding or the coil supporting structure. The present invention provides high rigidity high modulus structural support in both axial and radial (hoop) directions to the superconducting coil elements of the primary and shielding coils whereby high field magnetic resonance imaging (MRI) magnets can be consistently and reliably constructed without excessive deformation and the resulting heating, rise in temperature, loss of superconductivity, and in short quench. It is the objective of the present invention to provide efficient structural support and 12^{th} order uniform field in mri magnets by minimizing stress, coil deformation, and an ultrashort MRI magnet length less than 118 cm.

A superconducting magnet apparatus for MRI, of the present invention has a coldmass, which contains a rigid metal structure having load bearing strength of range 50-100 tons. This structure is capable of supporting electromagnetic force of 50-100 tons with trace deformation. Superconducting magnet elements include a superconducting coil group formed of plural superconducting coil elements. Trace deformation is defined as less than the amount of deformation to cause conductor slippage. In an embodiment wherein coil elements are potted in a matrix such as wax or epoxy but not limited to wax or epoxy, trace deformation is within the range of matrix cracking stress or within the elastic stress limit of supporting elements or within the frictional motion of conductor slippage.

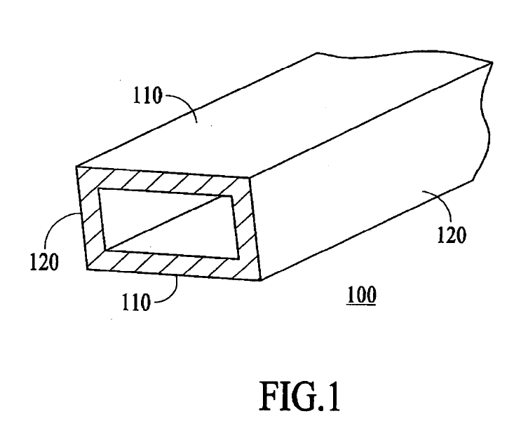

Referring now to the drawings, FIG. 1 illustrates a conventional box girder 100. A conventional box girder comprises at least two flanges and two webs. A flange 110 is generally a load bearing element such as a roadway. Flanges are generally parallel. Webs 120 are side walls used as stiffeners. The cross-section of a box girder may be trapezoidal or rectangular as long as each web is coupled to two flanges and each flange is coupled to at least two webs.

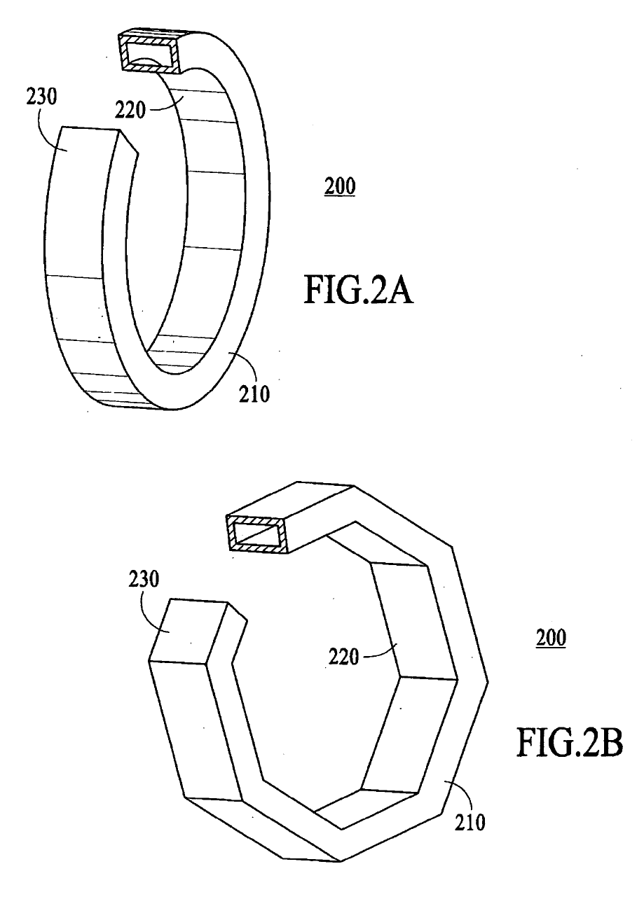

FIG. 2 illustrates an annular box girder of the present invention. A portion of the box girder is drawn in dashed lines to make the cross section viewable. The annular box girder 200 comprises two annular flanges 210 in parallel coupled rigidly by welding to an inner cylindrical web 220 and an outer cylindrical web 230. In the present invention of an MRI magnet, substantially all of the electromagnetic force is axial to the superconducting coil elements and is normal to the parallel annuluses 210 which we designate as flanges.

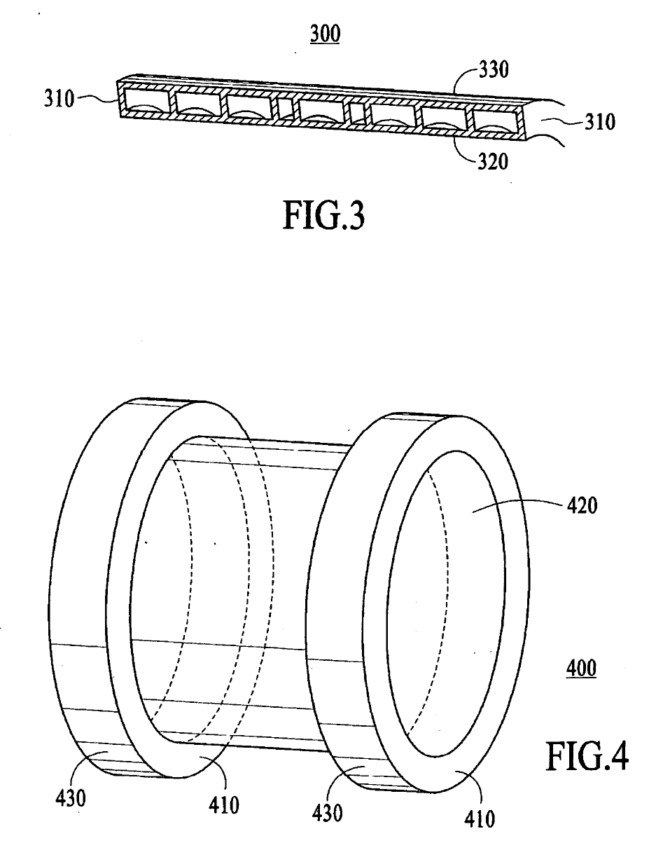

FIG. 3 illustrates a multi-cell annular box girder. A plurality of annular flanges 310 provide compartmentalization, and are stiffened by an inner cylindrical web 320 and an outer cylindrical web 330. It is known that box girders comprised of webs and flanges provide a much higher moment of inertia structure than simple open flange structure in the construction of bridges and buildings against gravitational and seismic forces.

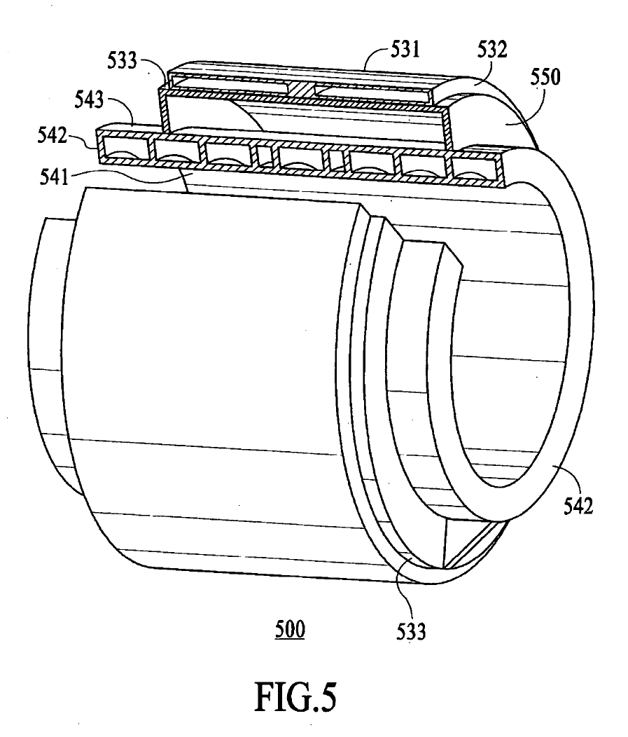

FIG. 4 illustrates a cutaway multi-cell annular box girder in perspective. A plurality of annular flanges 410 are coupled to an inner cylindrical web 420 and are further coupled to an outer cylindrical web 430. The two cylinders support the annuluses in axial loading to prevent deformation of superconducting coils formed between the inner and outer cylinders. The direction of current in the superconducting coil elements would generate electromagnetic force drawing the annuluses together if it were not for the inner and outer cylindrical webs.

FIG. 5 illustrates a multi-layer multi-cell box girder of the present invention. The inner layer provides a multi-cell box girder to support a plurality of primary coil elements with an inner cylindrical web 541, a plurality of annular flanges 542, and an outer primary coil box girder cylindrical web 543. The outer layer provides a multi-cell box girder to support a plurality of shield coil elements with an inner cylindrical web 533, a plurality of annular flanges 532, and an outer shield coil box girder cylindrical web 531. The inner primary cylinder 541 and the outer shield cylinder 531 along with a plurality of annuluses enclose a space for to contain a cryogen, and comprise the helium vessel.

It is preferred that gussets 550 are coupled to annuluses and cylinders to provide stiffness against torsional forces when both primary and shield superconducting coil elements are energized and are misaligned due to constructional tolerance.

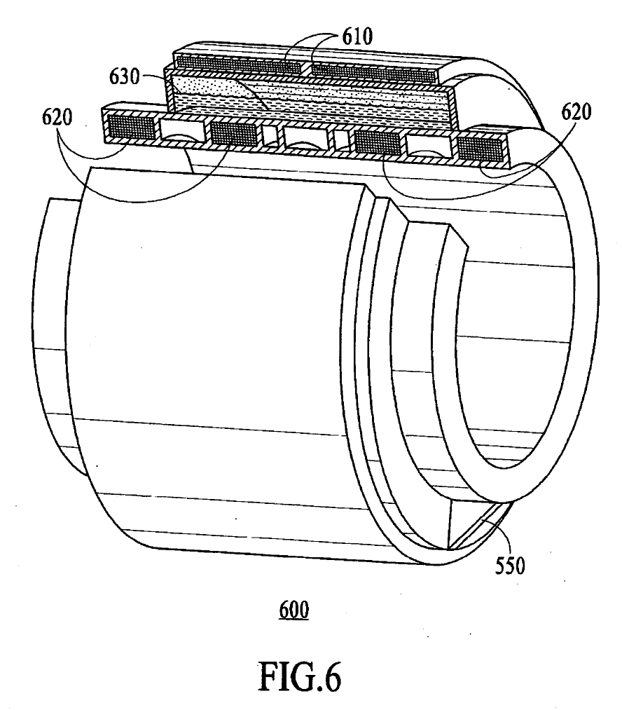

In FIG. 6 two shield coil elements 610 and a plurality of primary coil elements 620 are shown in an embodiment. In an embodiment the superconducting coil elements are potted in epoxy or wax within the cells defined by the annuluses and cylinders which are prevented from slippage by the box girders when the superconducting coil elements are energized thereby preventing heating from friction. A space between the primary coil box girder and the shield coil box girder 630 is further enclosed by annuluses and comprises the volume for a liquid cryogen, in an embodiment helium. Thus the helium vessel comprises a plurality of annuluses and a primary coil box girder and a shield box girder. In an embodiment there are 5 primary coil elements and two shield coil elements.

The coldmass includes a helium vessel for accommodating the superconducting coil groups and the rigid metal structure. The coldmass includes magnet elements, the structure support, and the helium vessel which maintains the coldmass at 4K. The weight of the coldmass in an embodiment is normally less than 4 tons. The coldmass is pivotally coupled to a plurality of coldmass suspenders coupled to a vacuum vessel for accommodating the coldmass and providing vacuum insulation by maintaining an interior under vacuum. The pivotal coupling allows contraction and expansion of the coldmass without thermally induced stress in the vacuum vessel, the helium vessel, or elements of the coldmass suspension system.

The coldmass suspenders are further coupled to a heat shield which is provided in a space between the helium vessel and the vacuum vessel to block off radiation heat to the helium vessel from the vacuum vessel. In an embodiment, the heat shield is thermally coupled to a 60-77K heat sink attached to a 77K coldhead first stage.

It is particularly disclosed that the electromagnetic force between the superconducting magnet elements is supported only by the rigid metal structure within the coldmass and only the gravitational force of the coldmass is supported in tension by the coldmass suspenders between the helium vessel and the vacuum vessel. This design arrangement greatly minimizes the heat leak from the 300K vacuum vessel to the 4.2K helium vessel. It is particularly disclosed that significant forces acting on the coldmass suspenders result from deceleration or accelerations of the vacuum vessel during transportation and gravity operating on the coldmass but that electromagnetic force between the coldmass and the non-magnetic vacuum vessel are negligible and the helium vessel may be dimensioned only to sustain the pressure of cryogen against a vacuum or magnet quench.

In an embodiment of the superconducting magnet apparatus for MRI, an antivibration bellows is coupled to a vacuum sleeve removeably coupled to a cryogen coldhead, whereby access to and maintenance of the coldhead is enabled without loss of cryogen or warming the magnet. This also allows transport of the magnet without a coldhead. A coldhead being a mechanical part, it is desireable to allow it to be removed, maintained, serviced, upgraded, or replaced without warming the magnet.

In an embodiment the cold head assembly comprises a Gifford-McMahon refrigerator cryocooler coupled to an anti-vibration bellows, and a plurality of springs which dampen the moment inertia of movement of the coldhead.

In an embodiment the plurality of suspenders comprise radial tension members attached to said coldmass allowing radial contraction of the coldmass as it is cooled without thermal stress whereby the angle between the tension member and the coldmass changes at a pivot pin coupling said tension member to the coldmass as the temperature of the coldmass changes and the diameter and length of the coldmass expands or contracts.

In an embodiment the plurality of suspenders comprise axial tension members attached to said coldmass allowing axial contraction of the coldmass as it is cooled without thermal stress wherein one end of each axial suspender is attached to the coldmass at a pivot pin coupling said tension member to the coldmass allowing the length of the coldmass to expand or contract as the temperature of the coldmass changes.

In an embodiment the plurality of suspenders comprise eight tension members further comprising pivotal fasteners at each end.

In an embodiment of the superconducting magnet apparatus for MRI the invention includes a coldmass suspender for pivotally coupling a vacuum vessel interior side to a heatshield and further pivotally coupling to a coldmass to achieve a structure that prevents thermal stress due to contraction during cryogen cooling of the coldmass. By properly sizing the inclined angle and by positioning a pivotal coupling, the contraction of the suspender and the contraction of the coldmass in substantially perpendicular directions during cooling can be equalized without changing the strain on the suspender.

In an embodiment of the present invention, the superconducting magnet apparatus for MRI further comprises a flexible bellows for transmitting gas from the helium vessel and for returning condensed liquefied helium to the helium vessel.

A superconducting magnet apparatus for MRI includes a coldmass, the coldmass comprising a rigid metal structure having load bearing strength of range 50-100 tons, supporting electromagnetic force with trace deformation, a superconducting coil group formed of plural superconducting coil elements, the coldmass further comprising
a cryogen vessel for accommodating the superconducting coil elements and the rigid metal structure, the coldmass pivotally coupled to
a plurality of coldmass suspenders coupled to
a vacuum vessel for accommodating the coldmass and providing vacuum insulation by maintaining an interior under vacuum, and the coldmass suspenders further coupled to
a heat shield that is provided in a space between the cryogen vessel and the vacuum vessel to block off radiation heat and to intercept heat flow to the cryogen vessel from the vacuum vessel; wherein, the electromagnetic force load between the superconducting magnet elements bears on only the rigid metal structure within the coldmass and not on the vacuum vessel and only the gravitational force of the coldmass is supported in tension by the coldmass suspenders between the cryogen vessel and the vacuum vessel.

The superconducting magnet apparatus for MRI has a rigid metal structure made of a plurality of cylinders for to support each superconducting coil element against forces in a radius direction and in an azimuthal direction. The cylinders are co-axial and concentric.

An embodiment of the superconducting magnet apparatus for MRI has a coldmass suspender for pivotally coupling a vacuum vessel interior side to a heatshield and further pivotally coupling to a coldmass to achieve a structure for to prevent induced stress due to thermal contraction during the coldmass cooldown.

The rigid metal structure design employs efficient structural design to achieve only trace deformation, wherein trace deformation is determined to transmit less than conductor slippage or epoxy cracking stress.

In an embodiment the superconducting magnet apparatus for MRI offers a flexible bellows for transmitting gas from the helium vessel and for returning condensed liquefied helium to the helium vessel.

The present invention is a multi-cylindrical apparatus for large patient bore ultra short mri magnet comprising a vacuum vessel, coupled to a plurality of coldmass suspenders, the suspenders coupled to a coldmass, the coldmass suspenders also coupled to a heatshield in the space interior of the vacuum vessel and exterior of the coldmass, the coldmass comprising a helium vessel, a plurality of superconducting electromagnet coil elements, and a rigid metal structure interior for to support superconducting electromagnet coil elements against deformation due to electromagnetic force.

In an embodiment the superconducting magnet apparatus for MRI has cold mass suspenders for axial direction supporting members for supporting the coldmass against a force in an axial direction, and radius direction supporting members for supporting the coldmass against forces in a radius direction and in an azimuthal direction.

The rigid metal structure comprises a plurality of cylinders for supporting each superconducting coil against forces in a radius direction and in an azimuthal direction.

In an embodiment the superconducting magnet apparatus for MRI has a plurality of annuluses rigidly attached to a plurality of cylinders containing superconducting coil elements forming cross-sectional boxes to achieve a high moment of inertia structure for to prevent deformation of the superconducting coil elements due to axial electro-magnetic forces, wherein the annuluses and cylinders are formed from 300 series non-magnetic stainless steel.

In an embodiment the superconducting magnet apparatus for MRI includes a coldmass suspender for pivotally coupling a vacuum vessel interior side to a heatshield and further pivotally coupling to a coldmass to achieve a structure for to prevent thermal stress due to contraction during cryogen cooling of the coldmass.

A superconducting magnet apparatus for MRI, is disclosed comprising: a coldmass, the coldmass comprising a rigid metal structure having load bearing strength of range 50-100 tons, supporting electromagnetic force with trace deformation, superconducting magnet elements including a superconducting coil group formed of plural superconducting coil elements,
the coldmass further comprising
a helium vessel for accommodating the superconducting coil groups and the rigid metal structure,
the coldmass pivotally coupled to
a plurality of coldmass suspenders pivotally coupled to
a vacuum vessel for accommodating the coldmass and providing vacuum insulation by maintaining an interior under vacuum, and the coldmass suspenders further coupled to
a heat shield that is provided in a space between the helium vessel and the vacuum vessel to block off radiation heat and intercept solid conduction heat to the helium vessel from the vacuum vessel;
wherein the rigid metal structure comprises a first cylindrical coil form coupled to, a plurality of annuluses for to support superconducting coil elements against axial forces said annuluses coupled to, a second cylindrical coil form, and coupled to an outer cylinder, each end capped by an annulus providing access to the center bore within the first cylindrical coil where a homogenous magnetic field is provided for imaging.

The present invention is a multi-cylindrical apparatus for enhanced patient bore mri magnet comprising a vacuum vessel, coupled to a plurality of coldmass suspenders, the suspenders coupled to a coldmass, the coldmass suspenders also coupled to a heatshield in the space interior of the vacuum vessel and exterior of the coldmass, the coldmass comprising a helium vessel, a plurality of superconducting electromagnet coil elements, and a parallel co-axial annular multi-cell box girder for to support primary superconducting electromagnet coil elements.

In the present invention, the parallel co-axial annular multi-cell box girder for to support primary superconducting electromagnet coils comprises a primary coil inner cylindrical box girder web, said web coupled to a plurality of primary coil parallel annular flanges, and said flanges coupled to a primary coil outer cylindrical box girder web.

In the present invention a parallel co-axial annular multi-cell box girder for shield coil elements is coupled to at least two annuluses coupled to the parallel co-axial annular multi-cell box girder for to support primary superconducting electromagnet coil elements wherein the space interior to the two annuluses and the two box girders defines a vessel for to contain helium.

In the present invention the parallel co-axial annular multi-cell box girder for shield coil elements comprises a shield coil inner cylindrical box girder web, a plurality of shield coil parallel annular flanges, and a shield coil outer cylindrical box girder web.

Each cylindrical box girder contains at least a superconducting electromagnetic coil element. In an embodiment the coil elements are embedded in a wax matrix. In an embodiment the coil elements are embedded in an epoxy matrix.

In a best mode of the invention, a plurality of gussetts is rigidly coupled to a cylindrical box girder and to an annulus for to counter torque due to electromagnetic force between the superconducting primary coil elements and the shielding coil elements.

An embodiment of the invention is an apparatus for a rigid coldmass apparatus for a superconducting mri magnet comprising an inner primary cylinder, coupled to a plurality of annuluses, coupled to an outer primary cylinder whereby a multi-cell annular box beam is formed to support superconducting coil elements against 50-100 tons of electromagnetic force without trace deformation wherein trace deformation causes conductor slippage which in turn causes quench.

The coldmass apparatus of the invention further has a plurality of annuluses coupled to the outer primary cylinder and further coupled to an inner shield cylinder whereby a helium vessel is enclosed in the space interior to the inner shield cylinder and exterior to the outer primary cylinder.

The coldmass apparatus of the invention also has a plurality of annuluses coupled to the inner shield cylinder and further coupled to an outer shield cylinder and superconducting coil elements interior to the outer cylinders and exterior to the inner cylinders wherein each cylinder and annulus comprises non-magnetic stainless steel dimensioned to support compression, tension, and torsional loading without substantial deformation and whereby a multi-layer multi-cell box beam is formed for to provide a high moment of inertia structure.

In an embodiment to improve strength and weight, the apparatus has a plurality of gussetts coupling cylinders at either end to annuluses for to increase rigidity, further comprising a plurality of pivotally coupled coldmass suspenders coupling the coldmass to the interior of a vacuum vessel, the coldmass suspenders further pivotally coupling a heatshield in the space interior of the vacuum vessel and exterior of the coldmass whereby electromagnet force generated by the superconducting coils of the cold mass is not substantially borne by the vacuum vessel and contraction force of the coldmass during cryogenic cooling is not substantially borne by the vacuum vessel.

### Conclusion

The present invention is distinguished by at least one annular box beam as a structural element within a multi-cylinder, multi-layer, multi-cell co-axial endless box girder supporting superconducting coil elements within a coldmass. Unlike conventional box beams the flanges are annuluses supporting the superconducting coils against axial forces. Unlike conventional box beams the webs are cylinders supporting the superconducting coils against radial and azimuthal forces electromagnetic. Unlike conventional box beams, the annular box beams are closed and are endless.

The present invention is distinguished from prior art conventional MRI magnets by the coldmass further comprising a rigid metal structure within the helium vessel to support a compressive load of 50-100 tons due to electromagnetic force between the elements of a superconducting magnet. The beneficial advantage over prior art of this distinguishing structure allows the helium vessel and its support through the vacuum vessel to be much thinner and lighter except where the coldmass is supported against gravitational force or accelerations during transport and installation. By limiting deformation of the superconducting coils, the frequency, inconvenience, and expense of recovering from magnet quench is minimized. The mass and expense of the helium vessel and the vacuum vessel may also be reduced as they do not bear the load of higher electromagnetic force enabled by this structure not appreciated in prior art. Finally, the image quality and length of time may be optimized by enabling a much stronger and larger homogenous magnetic field than conventional MRI magnets.

Embodiments of the present invention allow higher magnetic field strengths for higher quality imaging, quicker scans, less claustrophobia, improved interaction between patient and provider, and larger volumes or larger patients to be imaged than conventional mri magnets. Within the scope of the present invention and not departing from its meaning are annuluses comprised of curved or flat edges and cylinders comprised of curved or flat surfaces.

Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A superconducting magnet apparatus for MRI, comprising:
a coldmass, the coldmass comprising a rigid metal structure having load bearing strength of range 50-100 tons, supporting electromagnetic force with trace deformation,
a superconducting coil group formed of plural superconducting coils, the coldmass further comprising
a helium vessel for accommodating the superconducting coil groups and the rigid metal structure, and
a portion for connecting the helium vessel to the rigid metal structure, the coldmass pivotally coupled to
a plurality of coldmass suspenders coupled to
a vacuum vessel for accommodating the coldmass and providing vacuum insulation by maintaining an interior under vacuum, and the coldmass suspenders further coupled to
a heat shield that is provided in a space between the helium vessel and the vacuum vessel to block off radiation heat and intercept conduction heat to the helium vessel from the vacuum vessel.

2. The apparatus of claim 1 wherein, the electro-magnetic force load between the superconducting magnet elements bears on only the rigid metal structure within the coldmass and not on the vacuum vessel and only the gravitational force of the coldmass is supported in tension by the coldmass suspenders between the helium vessel and the vacuum vessel.

3. The apparatus according to claim 1, wherein: the cold mass suspenders comprise axial direction supporting members for supporting the coldmass against a force in an axial direction, and radius direction supporting members for supporting the coldmass against forces in a radius direction and in an azimuthal direction.

4. The superconducting magnet apparatus for MRI according to claim 1, further comprising: an antivibration bellows coupled to vacuum sleeve removeably coupled to a cryogen coldhead, whereby access to and maintenance of the coldhead is enabled without loss of cryogen or warming the magnet.

5. The superconducting magnet apparatus for MRI according to claim 1, wherein:
the rigid metal structure comprises a plurality of cylinders for to support each superconducting coil against forces in a radius direction and in an azimuthal direction.

6. The superconducting magnet apparatus for MRI according to claim 1, further comprising: a plurality of annuluses attached to a plurality of cylinders containing superconducting coils forming cross-sectional boxes for to achieve a high moment of inertia structure for to prevent deformation due to axial electro-magnetic forces.

7. The apparatus of claim 6 wherein the annuluses and cylinders are formed from 300 series non-magnetic stainless steel and further comprise flattened surfaces and edges in addition to curved surfaces and edges.

8. The superconducting magnet apparatus for MRI according to claim 1, further comprising: a coldmass suspender for pivotally coupling a vacuum vessel interior side to a heatshield and further pivotally coupling to a coldmass to achieve a structure for to prevent stress due to contraction during cryogen cooling of the coldmass.

9. The rigid metal structure supporting with trace deformation of claim 1, wherein trace deformation is determined within conductor slippage stress.

10. The superconducting magnet apparatus for MRI according to claim 1, further comprising: a flexible bellows for transmitting gas from the helium vessel and for returning condensed liquefied helium to the helium vessel.

11. A multi-cylindrical apparatus for short bore mri magnet comprising a vacuum vessel, coupled to a plurality of coldmass suspenders, the suspenders pivotally coupled to a coldmass, the coldmass suspenders also coupled to a heatshield in the space interior of the vacuum vessel and exterior of the coldmass, the coldmass comprising a helium vessel, a plurality of superconducting electromagnet coils, and a high modulus rigid metal structure interior for to support the superconducting electromagnet coils against deformation due to electromagnetic force coupled to the helium vessel.

12. The superconducting magnet apparatus for MRI according to claim 11, wherein:
the cold mass suspenders comprise axial direction supporting members for supporting the coldmass against a force in an axial direction.

13. The apparatus of claim 12 wherein coldmass suspenders further comprise radius direction supporting members for supporting the coldmass against forces in a radius direction and in an azimuthal direction.

14. The superconducting magnet apparatus for MRI according to claim 11, further comprising: an anti-vibration bellows coupled to a vacuum sleeve removeably coupled to a cryogen coldhead, whereby access to and maintenance of the coldhead is enabled without loss of cryogen or warming the magnet.

15. The superconducting magnet apparatus for MRI according to claim 11, wherein: the rigid metal structure comprises a plurality of cylinders for supporting each superconducting coil element against forces in a radius direction and in an azimuthal direction.

16. The superconducting magnet apparatus for MRI according to claim 11, further comprising: a plurality of annuluses rigidly attached to a plurality of cylinders containing superconducting coils forming cross-sectional boxes to achieve a high moment of inertia structure for to prevent deformation due to axial electro-magnetic forces.

17. The apparatus of claim 15 wherein the annuluses and cylinders are formed from 300 series non-magnetic stainless steel and may comprise flat edges and flat surfaces in addition to curved edges and curved surfaces.

18. The superconducting magnet apparatus for MRI according to claim 11, further comprising: a flexible bellows for transmitting gas from the helium vessel and for returning condensed liquefied helium to the helium vessel.

19. A superconducting magnet apparatus for MRI, comprising:
a coldmass, the coldmass comprising a rigid metal structure having load bearing strength of range 50-100 tons, supporting electro-magnetic force with trace deformation,
superconducting magnet elements including a superconducting coil group formed of plural superconducting coil elements,
the coldmass further comprising
a helium vessel for accommodating the superconducting coil groups and the rigid metal structure, the coldmass pivotally coupled to
a plurality of coldmass suspenders pivotally coupled to
a vacuum vessel for accommodating the coldmass and providing vacuum insulation by maintaining an interior under vacuum, and the coldmass suspenders further coupled to
a heat shield that is provided in a space between the helium vessel and the vacuum vessel to block off radiation heat and intercept conduction heat to the helium vessel from the vacuum vessel;
the vacuum vessel, the heat shield, and the helium vessel
allowing the installation of a pair of gradient coils within the magnet inner bore to generate
a gradient magnetic field, wherein: a homogeneous magnetic field and a linear gradient magnetic field are generated in a space; wherein, the electro-magnetic force between the superconducting magnet elements is supported only by the rigid metal structure within the coldmass and not bearing on the vacuum vessel walls and only the gravitational force of the coldmass is supported in tension by the coldmass suspenders between the helium vessel and the vacuum vessel;
wherein the rigid metal structure comprises a first cylindrical coil form coupled to, a plurality of annuluses for to support superconducting coil elements against axial forces coupled to, a second cylindrical coil form, and coupled to an outer cylinder, each end capped by an annulus providing access to the center bore within the first cylindrical coil where a homogenous magnetic field is provided for imaging.

20. A multi-cylindrical apparatus for enhanced bore mri magnet comprising a vacuum vessel, coupled to a plurality of coldmass suspenders, the suspenders coupled to a coldmass, the coldmass suspenders also coupled to a heatshield in the space interior of the vacuum vessel and exterior of the coldmass, the coldmass comprising a helium vessel, a plurality of superconducting electromagnet coil elements, wherein the helium vessel comprises a parallel co-axial annular multi-cell box girder for to support primary superconducting electromagnet coil elements.

21. The apparatus of claim 20 wherein the parallel co-axial annular multi-cell box girder for to support primary superconducting electromagnet coil elements comprises a primary coil inner cylindrical box girder web wall, said wall coupled to a plurality of primary coil parallel annular flanges, and said flanges coupled to a primary coil outer cylindrical box girder web wall.

22. The apparatus of claim 21 further comprising a parallel co-axial annular multi-cell box girder for shield coils coupled to at least two annuluses coupled to the parallel co-axial annular multi-cell box girder for to support primary superconducting electromagnet coil elements wherein the space interior to the two annuluses and the two box girders defines a vessel for to contain helium.

23. The apparatus of claim 22 wherein the parallel co-axial annular multi-cell box girder for shield coil elements comprises a shield coil inner cylindrical box girder web wall, a plurality of shield coil parallel annular flanges, and a shield coil outer cylindrical box girder web wall.

24. The apparatus of claim 23 wherein each annular box girder contains at least a superconducting electromagnetic coil element.

25. The apparatus of claim 23 further comprising a plurality of gussetts rigidly coupled to a cylindrical box girder and to an annulus for to prevent more than trace deformation due to electromagnetic force between the superconducting electromagnetic coils.

26. An apparatus for a rigid coldmass apparatus for a superconducting mri magnet comprising an inner primary cylinder, coupled to a plurality of annuluses, coupled to an outer primary cylinder whereby a multi-cell annular box beam is formed to support superconducting coil elements against 50-100 tons of electromagnetic force without deformation.

27. The coldmass apparatus of claim 26 further comprising a plurality of annuluses coupled the outer primary cylinder and further coupled to an inner shield cylinder whereby a helium vessel is enclosed in the space interior to the inner shield cylinder and exterior to the outer primary cylinder.

28. The coldmass apparatus of claim 27 further comprising a plurality of annuluses coupled to the inner shield cylinder and further coupled to an outer shield cylinder and superconducting coil elements interior to the outer cylinders and exterior to the inner cylinders wherein each cylinder and annulus comprises non-magnetic stainless steel dimensioned to support compression, tension, and torsional loading without conductor slippage and whereby a multi-layer multi-cell box beam is formed for to provide a high moment of inertia structure.

29. The apparatus of claim 28 further comprising a plurality of gussetts coupling cylinders to annuluses for to increase rigidity, further comprising a plurality of pivotally coupled coldmass suspenders coupling the coldmass to the interior of a vacuum vessel, the coldmass suspenders further pivotally coupling a heatshield in the space interior of the vacuum vessel and exterior of the coldmass whereby electromagnetic force generated by the superconducting coils of the cold mass is not substantially borne by the vacuum vessel and contraction force of the coldmass during cryogenic cooling is not substantially borne by the vacuum vessel.

30. An apparatus for a quench avoidant MRI magnet comprising at least five primary coil elements supported and enclosed within a first multi-cellular annular box girder, the girder coupled to a cryogen vessel, the cryogen vessel coupled to a second multi-cellular annular coil box girder, and at least two shield coil elements supported and enclosed by the second multi-cellular annular box girder.
